(19) United States
(12) Patent Application Publication
(10) Pub. No.: US 2008/0240744 A1
(43) Pub. Date: Oct. 2, 2008

(54) IMAGE FORMING APPARATUS AND METHOD TO CONTROL THE SAME

(75) Inventor: Chang Hyeon SHIM, Giheung-gu (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/045,800

(22) Filed: Mar. 11, 2008

(30) Foreign Application Priority Data
Mar. 27, 2007 (KR) 2007-29515

(51) Int. Cl. G03G 15/00

(52) U.S. Cl. 399/16

(57) ABSTRACT

An image forming apparatus includes an output control unit to change an output of an optical sensor to collectively recognize a plurality of print processes for a print job. The output control unit includes a first actuator to recognize whether paper is present in a printing medium cassette and a second actuator to recognize whether paper is being conveyed. This makes it possible to recognize whether paper is present in a printing medium cassette and whether paper is being conveyed based on the output of the optical sensor, thereby reducing a financial burden and preventing a reduction in a task efficiency of an optical sensor installation.

### CROSS-REFERENCE TO RELATED APPLICATIONS

This application claims priority under 35 U.S.C. §119(a) from Korean Patent Application No. 2007-0029515, filed on Mar. 27, 2007 in the Korean Intellectual Property Office, the disclosure of which is incorporated herein in its entirety by reference.

### BACKGROUND OF THE INVENTION

1. Field of the Invention

The present general inventive concept relates to an image forming apparatus and a method to control the same to improve a method to recognize a print process using an optical sensor, thereby achieving a reduction in a number of components of the apparatus.

2. Description of the Related Art

A general image forming apparatus performs a plurality of print processes to perform a print job such as inserting a paper cassette in its main body, picking up sheets of paper sheet by sheet from the paper cassette, and conveying each picked-up sheet along a paper conveyance path.

A controller in the image forming apparatus controls overall print processes and recognizes respective active states of the print processes to perform a print job according to a preset control program. In a typical example, the controller recognizes whether paper is present in the paper cassette. If no paper is present, the controller displays a message indicating that no paper is present to inform the user of the same. The controller also recognizes whether paper is being conveyed to recognize an occurrence of a jam and allows the user to take a measure against the jam.

Methods, which use optical sensors to recognize print processes such as checking whether paper is present and checking whether paper is being conveyed, are widely known. Korea Patent Application Publication No. 2004-0060364 describes a technology that determines an amount of waste toner in a waste toner container using a light emitter that emits light to the waste toner container and a light receiver that outputs a voltage corresponding to an amount of received light that has passed through the waste toner container.

The conventional method requires that an optical sensor be individually provided for each print process. Thus, a number of required optical sensors inevitably increases as a number of print processes to be recognized increases. This increases a financial burden and also increases an amount of an optical sensor installation task, thereby reducing an installation task efficiency.

### SUMMARY OF THE INVENTION

The general inventive concept provides an image forming apparatus and a method to control the same which are improved to collectively recognize a plurality of print processes for a print job according to an output of an optical sensor, thereby reducing a financial burden and preventing a reduction in a task efficiency of an optical sensor installation.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus having a plurality of print processes, the apparatus including an optical sensor including a light emitter and a light receiver, an output control unit to change an output of the optical sensor according to active states of the plurality of print processes and a controller to control a print job according to the output of the optical sensor.

The output control unit may selectively shield light from the light emitter to change the amount of light received by the light receiver.

The image forming apparatus may further include a light guide portion provided in a light path to guide light from the light emitter to the light receiver.

The light guide portion may have at least one guide hole to pass light.

The output control unit may include a first actuator to shield light from the light emitter according to whether paper is present and a second actuator to shield light from the light emitter according to whether paper is being conveyed.

The controller may display whether paper is present according to a level of the output of the optical sensor.

The controller may recognize whether paper is being conveyed according to a level of the output of the optical sensor.

The plurality of print processes may include an operation to check whether paper is present and to check whether paper is being conveyed.

The foregoing and/or other aspects and utilities of the present general inventive concept may also be achieved by providing an image forming apparatus including an optical sensor including a light emitter and a light receiver located, respectively, at both ends of a light path, a light guide portion provided in the light path to guide light from the light emitter, an output control unit to change an output of the optical sensor by controlling the amount of light passing through the light path according to whether paper is present and whether paper is being conveyed, and a controller to display whether paper is present and recognize whether paper is being conveyed according to a level of the output of the optical sensor.

The output control unit may include a first actuator to shield part of the light according to whether paper is present and a second actuator to shield part of the light according to whether paper is being conveyed.

The shape of the light path can be substantially changed by operations of the first and second actuators.

The light guide portion may have at least one guide hole to pass light from the light emitter and at least one guide recess to locate at least one of the first and second actuators in the light path.

Each of the first and second actuators may include a hinge shaft, a shielding plate, and a through-hole.

A first through-hole formed in the shielding plate of the first actuator and a second through-hole formed in the shielding plate of the second actuator can be out of alignment with respect to a center axis of the light path.

The first and second through-holes may have different sizes and a common space, and the first and second through-holes overlap each other, when both the first and second through-holes are located in the light path.

The first through-hole, the second through-hole, and the common space may pass different amounts of light.

The foregoing and/or other aspects and utilities of the present general inventive concept may also be achieved by providing a method to control an image forming apparatus, the method including mounting a light emitter and a light receiver, respectively, at both ends of a light path, guiding light emitted from the light emitter to the light receiver, shielding part of the light guided to the light receiver according to whether paper is present in a printing medium cassette, shielding part of the light guided to the light receiver according to whether paper is being conveyed from the printing medium cassette, changing an output voltage of the light receiver according to an amount of light received by the light receiver, and displaying whether paper is present in the cassette and recognizing whether paper is being conveyed according to the output voltage of the light receiver.

The foregoing and/or other aspects and utilities of the general inventive concept may also be achieved by providing an image forming apparatus including an optical sensor including a light receiver and a light emitter to emit light to the light receiver, and an actuator device moveably disposed between the light emitter and the light receiver to change an amount of light received by the light receiver based on a printing process stage of the image forming apparatus among a plurality of stages, wherein the optical sensor indicates states of a plurality of print processes based on the amount of light received by the light receiver.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating an example use of an image forming apparatus according to an embodiment of the present general inventive concept;

FIG. 2A is a view illustrating an operation of a first actuator to shield light according to whether paper is present according to an embodiment of the present general inventive concept;

FIG. 2B is a view illustrating an operation of a second actuator to shield light according to whether paper is being conveyed according to an embodiment of the present general inventive concept;

FIG. 3A is a view illustrating a sectional shape of a light path when paper is present and no sheet of paper is being conveyed according to an embodiment of the present general inventive concept;

FIG. 3B illustrates different sectional shapes of the light path according to operations of the first and second actuators according to an embodiment of the present general inventive concept;

FIG. 4 is a control block diagram illustrating an image forming apparatus according to an embodiment of the present general inventive concept; and

FIG. 5 is a flow chart illustrating a method to control an image forming apparatus according to an embodiment of the present general inventive concept.

### DETAILED DESCRIPTION OF THE PREFERRED EMBODIMENTS

Reference will now be made in detail to embodiments of the general inventive concept, examples of which are illustrated in the accompanying drawings, wherein like reference numerals refer to the like elements throughout. The embodiments are described below to explain the present invention by referring to the figures.

An image forming apparatus according to various embodiments of the present general inventive concept uses an optical sensor to collectively recognize a plurality of print processes for a print job. The plurality of print processes is a series of operations to process the print job. Although embodiments will be described focusing on operations to recognize whether paper is present in a printing medium cassette and whether paper is being conveyed, the present general inventive concept is not limited to such operations. That is, it is fully expected that the present general inventive concept can be applied to operations to recognize any other print processes using an optical sensor and thus a description of such operations will be omitted.

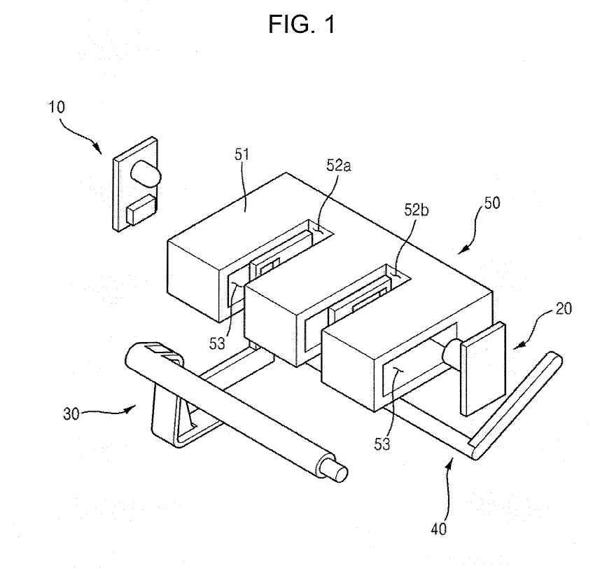

As illustrated in FIG. 1, an image forming apparatus according to an embodiment of the present general inventive concept includes an optical sensor 10 and 20 provided in a job space where a print job is performed.

The optical sensor includes a light emitter 10 and a light receiver 20.

The light emitter 10 and the light receiver 20 are arranged facing each other at both ends of a light path. The light emitter 10 may be embodied as a light emitting diode and the light receiver may be embodied as a phototransistor.

Light emitted from the light emitter 10 is transmitted to the light receiver 20. The light receiver 20 receives the light from the light emitter 10 and outputs a voltage corresponding to an amount of the received light.

A light guide portion 50 is provided between the light emitter 10 and the light receiver 20 to guide light from the light emitter 10 to the light receiver 20. Even when the light guide portion 50 is not provided, it is possible to transmit light from the light emitter 10 to the light receiver 20. However, without the light guide portion 50, light transmission efficiency may be reduced. Accordingly, it can be necessary to locate the light emitter 10 and the light receiver 20 very close to each other to secure an output sensitivity of the optical sensor.

The light guide portion 50 includes a body 51 in which three guide holes 53 are formed to guide light from the light emitter 10. Two guide recesses 52a and 52b are formed between the guide holes 53. The guide holes 53 are formed such that the light path from the light emitter 10 to the light receiver 20 passes through a center axis of the guide holes 53.

Referring to FIG. 1, image forming apparatus according to the present embodiment further includes an output control unit 30 and 40 to change an output of the optical sensor to collectively recognize a plurality of print processes.

The output control unit includes a first actuator 30 to recognize whether paper is present in a printing medium cassette and a second actuator 40 to recognize whether paper is being conveyed.

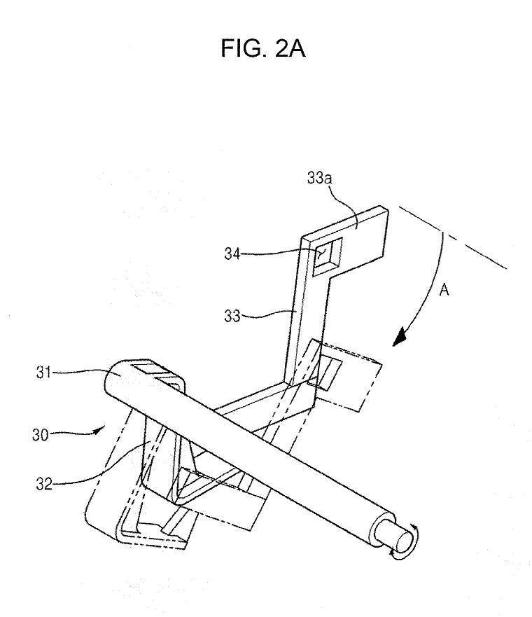

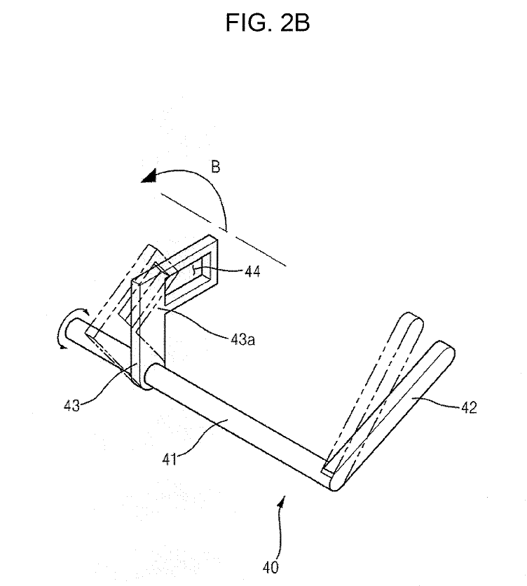

As illustrated in FIG. 2A, the first actuator 30 includes a hinge shaft 31, a printing medium holder 32, and a connector 33. The hinge shaft 31 is rotatably mounted in the apparatus. The printing medium holder 32 is operatively connected to the hinge shaft 31 to hold a printing medium such as paper. The connector 33 has one end extending from the holder 32 and includes a first shielding plate 33a that enters and exits the first guide recess 52a (FIG. 1) with rotation of the hinge shaft 31.

A first through-hole 34 having a predetermined size is formed in the first shielding plate 33a to pass light.

If paper is present in the cassette, the first shielding plate 33a is located in the first guide recess 52a to selectively shield light that passes through the guide hole 53. That is, the first shielding plate 33a shields one part of the light while allowing another part to pass through the first through-hole 34.

If a number of sheets of printing medium such as paper 2 stored in the printing medium cassette 1 becomes zero as a print job proceeds, the printing medium holder 32 moves downward. Accordingly, the first shielding plate 33a rotates in a direction as denoted by an arrow A. Accordingly, the first shielding plate 33a moves out of the first guide recess 52a (FIG. 1) to allow light to pass through the guide hole 53 (FIG. 1) without being shielded.

As illustrated in FIG. 2B, the second actuator 40 includes a hinge shaft 41, a printing medium touch bar 42, and a connector 43. The hinge shaft 41 is rotatably mounted in the image forming apparatus. The printing medium touch bar 42 is fixed to the hinge shaft 41 to operate together with the hinge shaft 41 as paper is conveyed. The connector 43 includes a second shielding plate 43a that enters and exits the second guide recess 52b (FIG. 1) with rotation of the printing medium touch bar 42.

A second through-hole 44 having a predetermined size is formed in the second shielding plate 43a to pass light.

If no sheet of paper is being conveyed, the second shielding plate 43a is located in the second guide recess 52b to selectively shield light that passes through the guide hole 53. That is, the second shielding plate 43a shields part of the light while allowing another part to pass through the second through-hole 44.

If a sheet of paper is being conveyed to perform a print job, the sheet of paper proceeds after hitting the printing medium touch bar 42 to cause the hinge shaft 41 to rotate in a direction as denoted by an arrow B. Accordingly, the second shielding plate 43a moves out of the second guide recess 52b (FIG. 1) to allow light to pass through the guide hole 53 (FIG. 1).

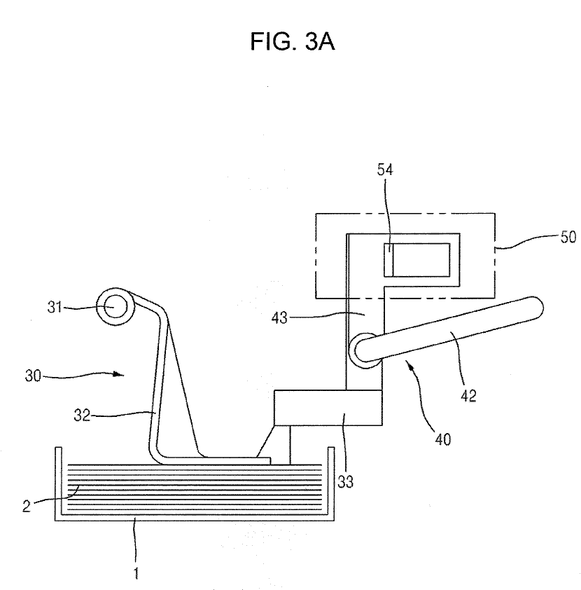

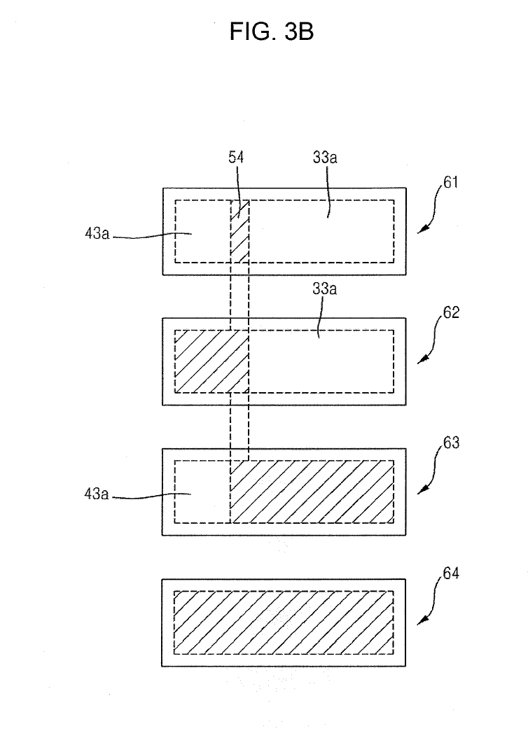

Referring to FIGS. 1-3A, if paper 2 is present and no sheet of paper is being conveyed, the first shielding plate 33a is located in the first guide recess 52a and the second shielding plate 43a is located in the second guide recess 52b. At this time, the first through-hole 34 formed in the first shielding plate 33a and the second through-hole 44 formed in the second shielding plate 43a, which have different sizes, are out of alignment with respect to a center axis of the light path to form a common portion 54 where the first and second through-holes 34 and 44 overlap each other.

In this manner, operations of the first and second actuators 30 and 40 determine positions of the first and second shielding plates 33a and 43a. Accordingly, the light shielding state, in which light passing through the guide hole 53 is shielded, changes according to the positions of the first and second shielding plates 33a and 43a. That is, there are four light shielding states, i.e., a state in which light is shielded by one of the first and second shielding plates 33a and 43a, a state in which light is shielded by the other of the first and second shielding plates 33a and 43a, a state in which light is shielded by both the first and second shielding plates 33a and 43a, and a state in which light is not shielded by any of the first and second shielding plates 33a and 43a. The shape (specifically, sectional shape) of the light path differs for each of the light shielding states and the amount of light received by the light receiver 20 changes according to the sectional shape of the light path. The output voltage of the light receiver 20 changes as the amount of light received by the light receiver 20 changes.

Referring to FIGS. 1-2B and 3B, the sectional shapes of the light path according to the operations of the first and second actuators 30 and 40 can be divided into various shapes. The various shapes may include a shape 61 where paper is present and no sheet of paper is being conveyed so that light is shielded by both the first and second shielding plates 33a and 43a to allow light to pass through the common portion 54. The various shapes may also include a shape 62 where paper is present and a sheet of paper is being conveyed so that light is shielded by only the first shielding plate 33a to allow light to pass through the first through-hole 34. The various shapes may also include a shape 63 where no paper is present and no sheet of paper is being conveyed so that light is shielded by only the second shielding plate 43a to allow light to pass through the second through-hole 44. The various shapes may also include a shape 64 where no paper is present and a sheet of paper is being conveyed so that light is not shielded by any of the first and second shielding plates 33a and 3a to allow light to pass through the guide hole 53.

Such relationships can be represented by the following table.

| | Whether | light receiver | | |
|---|---|---|---|---|
| Whether | paper | Amount of | | Sectional |
| paper is | is being | Received | Output | Shape of |
| present | conveyed | Light | Voltage | Light Path |
| no paperis present | paper isbeingconveyed | L1 | V4 | 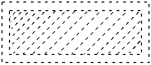 |
| no paperis present | no paperis beingconveyed | L2 | V3 | 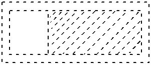 |
| paperis present | paper isbeingconveyed | L3 | V2 | 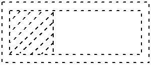 |
| paperis present | no paperis beingconveyed | L4 | V1 | 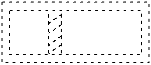 |

Here, amounts of received light L1, L2, L3, and L4 are such that L1>L2>L3>L4 and levels of the output voltages V1, V2, V3, and V4 are such that V1>V2>V3>V4.

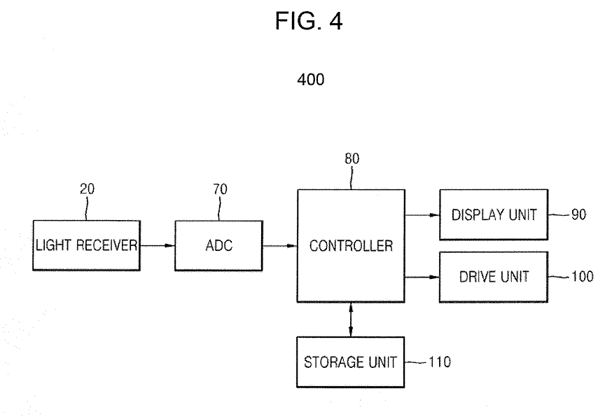

FIG. 4 is a control block diagram illustrating an image forming apparatus according to an embodiment of the present general inventive concept.

As illustrated in FIG. 4, the image forming apparatus 400 according to an embodiment of the present general inventive concept includes a light receiver 20, an analog to digital converter (ADC) 70, a controller 80, a display unit 90, a drive unit 100, and a storage unit 110. The ADC 70 converts an output voltage from the light receiver 20 into digital data readable by the controller 80. The controller 80 receives the converted output voltage data from the ADC 70 and compares it with reference levels stored in the storage unit 110 to recognize whether paper is present in the cassette and whether a sheet of paper is being conveyed. The display unit 90 displays whether paper is present under control of the controller 80 to allow the user to confirm whether paper is present. Under control of the controller 80, the drive unit 100 drives a motor that provides a drive force to a number of conveyor rollers (not illustrated) to convey paper.

When it recognizes that no paper is present based on the output voltage of the light receiver 20, the controller 80 controls the display unit 90 to display a message requesting the user to add paper to the printing medium cassette.

When it recognizes that a sheet of paper is being conveyed based on the output voltage of the light receiver 20, the controller 80 controls the drive unit 100 to drive the motor to convey paper at preset timings.

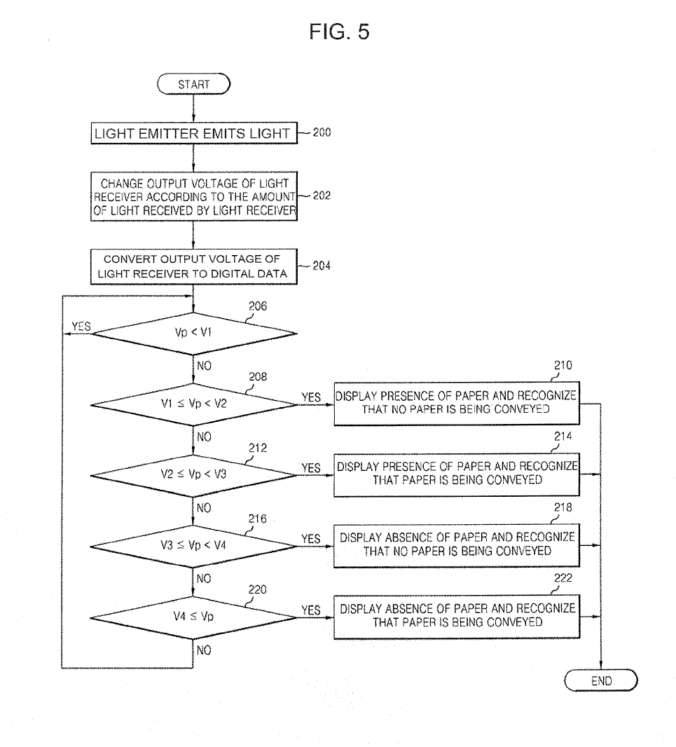

A method to control an image forming apparatus according to an embodiment of the present general inventive concept will now be described with reference to FIG. 5.

First, as power is supplied to the image forming apparatus, the light emitter 10 emits light (operation 200). The first and second actuators 30 and 40 perform light shielding operations according to whether paper is present and whether paper is being conveyed and the light receiver 20 changes output voltage therefrom according to the amount of received light (operation 202).

The ADC 70 converts the output voltage Vp of the light receiver 20 into digital data and provides the digital data to the controller 80 (operation 204).

The controller 80 determines whether the output voltage Vp is less than a first reference level V1 (operation 206). If it is determined that the output voltage Vp is less than the first reference level V1, the controller 80 repeats the determination. If it is determined that the output voltage Vp is not less than the first reference level V1, the controller 80 determines whether the output voltage Vp is within a range of not less than the first reference level V1 and less than a second reference level V2 (operation 208).

If it is determined in operation 208 that the output voltage Vp is within the range of not less than the first reference level V1 and less than the second reference level V2, the controller 80 causes the display unit 90 to display a presence of paper and recognizes that paper is not being conveyed (operation 210).

If it is determined in operation 208 that the output voltage Vp is not within the range of not less than the first reference level V1 and less than the second reference level V2, the controller 80 determines whether the output voltage Vp is within a range of not less than the second reference level V2 and less than a third reference level V3 (operation 212).

If it is determined in operation 212 that the output voltage Vp is within the range of not less than the second reference level V2 and less than the third reference level V3, the controller 80 causes the display unit 90 to display a presence of paper and recognizes that paper is being conveyed (operation 214).

If it is determined in operation 212 that the output voltage Vp is not within the range of not less than the second reference level V2 and less than the third reference level V3, the controller 80 determines whether the output voltage Vp is within a range of not less than the third reference level V3 and less than a fourth reference level V4 (operation 216).

If it is determined in operation 216 that the output voltage Vp is within the range of not less than the third reference level V3 and less than the fourth reference level V4, the controller 80 causes the display unit 90 to display an absence of paper and recognizes that paper is not being conveyed (operation 218).

If it is determined in operation 216 that the output voltage Vp is not within the range of not less than the third reference level V3 and less than the fourth reference level V4, the controller 80 determines whether the output voltage Vp is equal to or higher than the fourth reference level V4 (operation 220). If it is determined that the output voltage Vp is less than the fourth reference level V4, the controller 80 returns to operation 206. If it is determined that the output voltage Vp is equal to or higher than the fourth reference level V4, the controller 80 causes the display unit 90 to display an absence of paper and recognizes that paper is being conveyed (operation 222).

As is apparent from the above description, an image forming apparatus and a method to control the same according to various embodiments of the present general inventive concept collectively recognize a plurality of print processes based on an output of an optical sensor. This can reduce a number of required optical sensors, thereby reducing a financial burden and preventing a reduction in the task efficiency of an optical sensor installation.

Although various embodiments of the present general inventive concept have been illustrated and described, it would be appreciated by those skilled in the art that changes may be made in these embodiments without departing from the principles and spirit of the invention, the scope of which is defined in the claims and their equivalents.

What is claimed is:

1. An image forming apparatus having a plurality of print processes, the apparatus comprising:
an optical sensor including a light emitter and a light receiver;
an output control unit to change an output of the optical sensor according to active states of the plurality of print processes; and
a controller to control a print job according to the output of the optical sensor.

2. The image forming apparatus according to claim 1, wherein the output control unit selectively shields light from the light emitter to change an amount of light received by the light receiver.

3. The image forming apparatus according to claim 1, further comprising:
a light guide portion provided in a light path to guide light from the light emitter to the light receiver.

4. The image forming apparatus according to claim 3, wherein the light guide portion comprises:
at least one guide hole to pass light.

5. The image forming apparatus according to claim 2, wherein the output control unit comprises:
a first actuator to shield light from the light emitter according to whether paper is present; and
a second actuator to shield light from the light emitter according to whether paper is being conveyed.

6. The image forming apparatus according to claim 5, wherein the controller displays whether paper is present according to a level of the output of the optical sensor.

7. The image forming apparatus according to claim 5, wherein the controller recognizes whether paper is being conveyed according to a level of the output of the optical sensor.

8. The image forming apparatus according to claim 1, wherein the plurality of print processes includes an operation to check whether paper is present and to check whether paper is being conveyed.

9. An image forming apparatus, comprising:
an optical sensor including a light emitter and a light receiver located, respectively, at both ends of a light path;
a light guide portion provided in the light path to guide light from the light emitter;
an output control unit to change an output of the optical sensor by controlling an amount of light passing through the light path according to whether paper is present and whether paper is being conveyed; and
a controller to display whether paper is present and to recognize whether paper is being conveyed according to a level of the output of the optical sensor.

10. The image forming apparatus according to claim 9, wherein the output control unit comprises:
a first actuator to shield part of the light according to whether paper is present; and
a second actuator to shield part of the light according to whether paper is being conveyed.

11. The image forming apparatus according to claim 10, wherein a shape of the light path is substantially changed by operations of the first and second actuators.

12. The image forming apparatus according to claim 10, wherein the light guide portion comprises:
at least one guide hole to pass light from the light emitter; and
at least one guide recess to locate at least one of the first and second actuators in the light path.

13. The image forming apparatus according to claim 10, wherein each of the first and second actuators comprises:
a hinge shaft;
a shielding plate; and
a through-hole.

14. The image forming apparatus according to claim 13, wherein a first through-hole formed in the shielding plate of the first actuator and a second through-hole formed in the shielding plate of the second actuator are out of alignment with respect to a center axis of the light path.

15. The image forming apparatus according to claim 14, wherein the first and second through-holes have different sizes and a common space, and the first and second through-holes overlap each other, when both the first and second through-holes are located in the light path.

16. The image forming apparatus according to claim 15, wherein the first through-hole, the second through-hole, and the common space pass different amounts of light.

17. A method to control an image forming apparatus, the method comprising:
mounting a light emitter and a light receiver, respectively, at both ends of a light path in a job space to perform a plurality of print processes;
allowing the light emitter to emit light;
changing an output of the light receiver according to active states of the plurality of print processes; and
controlling a print job by recognizing a print process according to the output of the light receiver.

18. The method according to claim 17, wherein the changing of the output of the light receiver includes:
guiding light from the light emitter to the light receiver; and
selectively shielding light that passes through the light path according to active states of the plurality of processes.

19. The method according to claim 17, wherein the controlling of the print job includes comparing a level of the output of the light receiver with reference levels corresponding to the plurality of print processes.

20. A method to control an image forming apparatus, the method comprising:
mounting a light emitter and a light receiver, respectively, at both ends of a light path;
guiding light emitted from the light emitter to the light receiver;
shielding part of the light guided to the light receiver according to whether paper is present in a printing medium cassette;
shielding part of the light guided to the light receiver according to whether paper is being conveyed from the printing medium cassette;
changing an output voltage of the light receiver according to an amount of light received by the light receiver; and
displaying whether paper is present in the cassette and recognizing whether paper is being conveyed according to the output voltage of the light receiver.

21. An image forming apparatus, comprising:
an optical sensor including a light receiver and a light emitter to emit light to the light receiver; and
an actuator device moveably disposed between the light emitter and the light receiver to change an amount of light received by the light receiver based on a printing process stage of the image forming apparatus among a plurality of stages,
wherein the optical sensor indicates states of a plurality of print processes based on the amount of light received by the light receiver.

22. The image forming apparatus according to claim 21, further comprising:
a controller to control the print processes based on the indicated states of the plurality of print processes.

23. The image forming apparatus according to claim 22, wherein the states of the plurality of print processes include an existence or non-existence of a printing medium, and a conveyance or non-conveyance of the printing medium.

24. The image forming apparatus according to claim 23, wherein the actuator unit further comprising:
a first actuator and a second actuator, each one having a through-hole and a light shielding portion to change the light received by the light receiver independently or in combination.

25. The image forming apparatus according to claim 22, wherein the optical sensor indicates the states of the plurality of print processes by outputting a voltage level corresponding to the amount of light received by the light receiver thereof.
